(19) United States
(12) Patent Application Publication
(10) Pub. No.: US 2007/0091875 A1
(43) Pub. Date: Apr. 26, 2007

(54) Method and System For Device Mobility Using Application Label Switching In A Mobile Communication Network

(75) Inventor: Shareq Rahman, San Jose, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: RevNX, Inc.

(21) Appl. No.: 11/551,533

(22) Filed: Oct. 20, 2006

Related U.S. Application Data
(60) Provisional application No. 60/596,810, filed on Oct. 22, 2005.
(60) Provisional application No. 60/596,969, filed on Nov. 2, 2005.

(51) Int. Cl. G06F 15/16

(52) U.S. Cl. 370/352; 709/227

(57) ABSTRACT

A method and system for device mobility using application label switching in a mobile communication network are disclosed. In one embodiment, the method comprises establishing an application session involving a first computing device, a second computing device, a client application and a server application. The application session includes, a first unbreakable session between the client application and the first computing device, a second unbreakable session between the server application and the second computing device, and one or more breakable sessions between the first computing device and the second computing device. The first unbreakable session and the second unbreakable session are maintained when the one or more breakable sessions terminate. One or more new breakable sessions are created when the one or more breakable sessions terminate. The application session is reestablished with the one or more new breakable sessions, the first unbreakable session and the second unbreakable session.

The present application claims the benefit of and priority to U.S. Provisional Patent Application No. 60/596,810 entitled “Method and Apparatus for Device Mobility Using Application Label Switching In A Mobile Communication Network” and filed on Oct. 22, 2005, and U.S. Provisional Patent Application No. 60/596,969 entitled “Method and Apparatus for Device Mobility Using Application Label Switching In A Mobile Communication Network” and filed on Nov. 2, 2005, and are hereby, incorporated by reference.

### FIELD OF THE INVENTION

The field of the invention relates generally to wireless networks, and more particularly to providing a transparent application level communication mechanism among networked mobile and fixed nodes.

### BACKGROUND

With the advent of new wireless technologies, mobile devices are becoming more and more commonplace these days. Mobile devices are expected to provide similar functionality that desktop computers can provide, and these functionalities include instant access to email, web, etc. Mobile devices are also becoming increasingly popular in the enterprise market for accessing behind-the-firewall enterprise data in a secure fashion.

Applications running on mobile devices must deal with the idiosyncrasies of a wireless network, which include intermittent connections due to poor coverage, and the frequent change of network address due to roaming. These are particularly problematic for session oriented network applications including applications that use the TCP protocol. A disconnection due to wireless coverage problem or a network address change results in the premature termination of session oriented applications.

Due to the limited number of Internet Protocol (IP) Version 4 addresses, mobile wireless operators tend to use private IP addresses for its subscribed mobile devices. Use of private addresses makes the mobile devices non-routable in the Internet. The limited number of IP Version 4 addresses and the use of private IP addresses are specially problematic when a mobile device plays a well-known server role, such as in Peer-to-Peer (P2P) networking.

In certain mobile wireless operators' networks, a mobile device is allocated an IP address only for the duration of time the device is engaged in data communication. At other times the network takes away the IP address from the idle mobile device and allocates it to another active mobile device. This type of dynamic change in IP address binding results in the premature termination of a session based application that depends on the IP addresses to be the same throughout the duration of its execution.

### SUMMARY

A method and system for device mobility using application label switching in a mobile communication network are disclosed. In one embodiment, a method comprises establishing an end-to-end application session involving a software application running on a client computing device, the client computing device, an unreliable network such as a mobile network, a server computing device, and another software application running on the server computing device. The application session includes an unbreakable session between the client software application and the client computing device, a breakable session between the client computing device and the mobile network, another breakable session between the mobile network and the server computing device, and finally another unbreakable session between the server computing device and the server software application. Data is received at the computing device during the application session from the server via the unreliable network. The application session is maintained even when the connectivity to the unreliable network is lost, in other words when any of the breakable sessions breaks. The application session seamlessly resumes when data connectivity is restored.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 is a block diagram of an exemplary communications network implementing an application label switching based communication system, according to one embodiment of the present invention.

FIG. 2 illustrates a block diagram of an exemplary application label switching router gateway, according to one embodiment of the present invention.

FIG. 3 illustrates a block diagram of an exemplary application label switching router, according to one embodiment of the present invention.

FIG. 4 illustrates a block diagram of an exemplary registration server, according to one embodiment of the present invention.

FIG. 5 illustrates a block diagram of exemplary internal tables in an application label switching router and an application label switching router gateway, according to one embodiment of the present invention.

FIG. 6 illustrates a block diagram of an exemplary application label switching unaware mobile device accessing services offered through an application service provider, according to one embodiment of the present invention.

FIG. 7 illustrates a block diagram of an exemplary enterprise model where mobile users can access data behind-the-firewall, according to one embodiment of the present invention.

FIG. 8 illustrates a block diagram of an exemplary virtual private network client on a mobile device using the application label switching system, according to one embodiment of the present invention.

### DETAILED DESCRIPTION

A method and system for device mobility using application label switching in a mobile communication network are disclosed. In one embodiment, a method comprises establishing an end-to-end application session (will be referred to as simply an application session hereafter) involving a mobile device, a mobile network, and a server. The application session includes a number of unbreakable sessions and a number of breakable sessions: a breakable session goes over an unreliable network such as a mobile network; an unbreakable session goes over a reliable network. For example, a session that is locally terminated on the same device or that goes over a reliable network could be an unbreakable session. Data is received at the mobile device during the application session from the server via the mobile network. The application session is maintained when any of the breakable sessions, for example one that goes over the wireless network, terminates. A second breakable session is created and linked with the application session. In one embodiment, a second breakable session is created even though the first breakable session remains operational. The second breakable session is linked with the application session and only then the first breakable session is explicitly terminated. In another embodiment the data protocol used in the first breakable session may be different from that of the second breakable session as the latter replaces the former. For example, if the first breakable session was using UDP it is possible the second breakable session that replaces the first one could use TCP.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The present method and system utilizes application label switching (ALS) for switching application traffic from one communicating node to another. Such an ALS aware communicating node is defined to be an application label switching router (ALSR). Between two such adjacent ALSRs, an application label switching session exists. Such a session is a breakable session and is resilient to network connectivity problems. If this session drops due to a communication problem, the session is re-negotiated automatically. An application label-switching path (ALSP) starts at an ALSR, goes through multiple ALSRs in tandem and ends at another ALSR. Since the ALS session between any two adjacent ALSRs are resilient to communication problems, any of the ALSRs could be mobile devices residing in a wireless network. The end-to-end application traffic going over an ALSP will be transparent to the fact that one or more of the communicating nodes are mobile and can change IP addresses at any point in time. The beginning and end ALSRs interact with standard software applications using standard or proprietary protocols. A standard software application (will be referred to as simply an application hereafter) is a computer program developed with or without the knowledge of the present methods and systems described herein and the application interacts with another computer program over a communication network. A Web Browser is an example of an application which is already available off-the-shelf and is developed without the knowledge of the ALS technology defined in this invention. It can be appreciated by those skilled in the art, that an application can play the role of a client or a server or both. For example, a Web Browser application plays the role of a client (such applications will be referred to as a client application hereafter) whereas a Web server such as Apache Web Server plays the role of a server (such applications will be referred to as server application hereafter). The ALSRs on the edges of an ALSP will be referred to as ALSR gateways (ALSRGW).

The present system also relates to a method of manual or automatic provisioning of ALSPs among the ALSRs and ALSRGWs such that application traffic originating from the conventional node destined to the peer conventional node can be mapped onto one of such ALSPs.

According to one embodiment, a method is desired for seamless communication between a conventional mobile device (i.e., a networked PDA, smart phone, a laptop with wireless access, etc.), and a conventional fixed host on the Internet or in a private network, such that behaviors of the wireless network are transparent to both of the conventional nodes. According to this embodiment, applications on the mobile device access the ALSP service in a standard way (for example via a BSD socket service) such that the application itself does not need any proprietary changes. An ALSP will be automatically provisioned for this application such that a communication channel opens up between the two conventional nodes. Since an ALSP provides a resilient communication channel hiding all the complexities of the wireless network, seamless application mobility is achieved.

According to another embodiment, a method exists for providing a seamless application communication mechanism between two conventional mobile devices. Similarly, both of the mobile devices use the ALSP service to achieve application mobility.

According to another embodiment, a method exists for providing a seamless application communication mechanism between two conventional fixed nodes, at least one of which is using unreliable access mechanisms such as dial-up connections with the possibility of frequent disconnections and automatic IP address changes.

According to another embodiment, a method exists to allow a mobility unaware application service provider (ASP) to tap into a mobile subscriber base by registering with the ALS service. Such a registration allows an ALS service provider to access one or more application servers residing in the ASP such that the ASP itself does not need to be aware of the ALS service, nor does it require any custom hardware in its network to get this service.

According to another embodiment, a method exists to allow network connected computing devices to use the ALS services from a remote node.

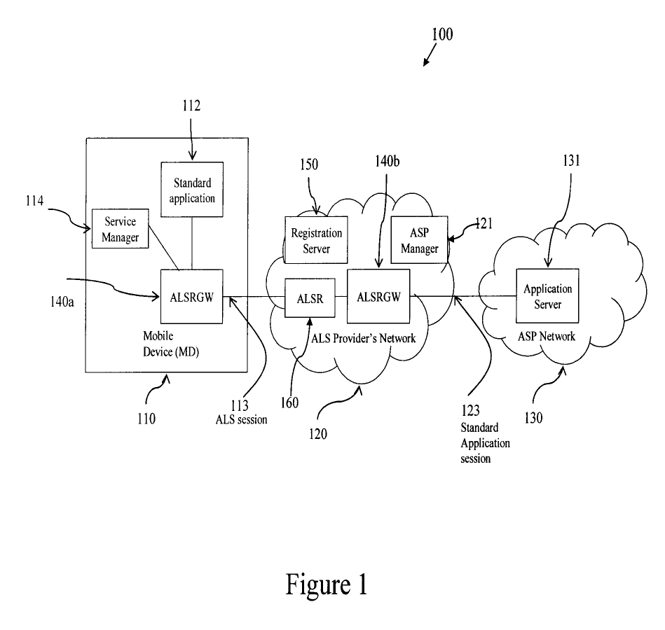

FIG. 1 is a block diagram of an exemplary communications network implementing an application label switching based communication system, according to one embodiment of the present invention. With system 100 an independent ASP network 130 can register a number of services with ALS service provider's network 120 via the ASP manager 121. Registration allows the independent ASP 130 to provide services to a mobile user base (not shown) owned by the ALS provider's network 120.

In system 100, a mobile device 110 is subscribed to the ALS provider's network 120 and is running ALS software, and the ALSRGW 140a running on the mobile device 110 registers with the ALS provider's network 120 via the registration server (RS) 150. This registration server authenticates and authorizes the ALSRGW 140a, and accordingly the mobile device 110. The registration server 150 also provides identifiers of all the ASPs the mobile device 110 has been pre-configured for via the ASP manager 121. ALSRGW 140a receives all the services the mobile device 110 is allowed to access on each of the ASPs.

According to one embodiment, ALSRGW 140a creates an ALS session 113 with the neighboring ALSR 160. ALSRGW 140a sends a set of labels to ALSR 160 describing all the ASP networks that ALSRGW 140a has access to. In this example, the application 112 running in the mobile device 110 reaches the ALSRGW 140a running in 110. It should be appreciated that mobile device 110 can also be a “gateway” to other ASPs. ALSR 160 receives label information from its neighbors and updates its tables. Label information received from direct neighbors is an example of an implicit ALSP setup procedure according to one embodiment of this invention. Such labels indicate how to reach an ASP, but not necessarily how to acquire the services. Both ALSRGW 140a and ALSR 160 maintain a label-mapping table for application traffic switching. It should be noted that implicitly setup ALSPs are tier-1 ALSPs, which route data between ASPs.

According to another embodiment, ALSRGW 140a creates a local socket listener for each of the services the mobile device 110 has been pre-configured for. It should be appreciated that each local socket listener represents a remote service offered by a particular ASP. For example, a socket listener for local port 5678 on the mobile device 110 may represent the POP3 service offered by the ASP 130.

According to another embodiment, applications running on the mobile device 110 may programmatically query such local socket entities from the ALSRGW 140a to identify the local port number assigned to a corresponding remote ASP and the desired service information. In another embodiment, a user of the mobile device 110 may use the service manager 114 to visually inspect all the socket bindings available from ALSRGW 1403a.

In system 100, a mobile user can launch a standard application 112 that uses a local port on the mobile device 110 to get access to remote services offered by ASP 130 on its application server 131. For example, the user can configure a standard POP3 client to access the local mobile device 110 at port 5678 where port 5678 has been configured to represent the remote POP3 service offered by ASP 130.

In system 100, a tier-2 ALSP starts when the standard application 112 connects with a local port at ALSRGW 140a. According to one embodiment, ALSRGW 140a uses an application label distribution protocol (ALDP) to configure the label map between itself and ALSRGW 140b to access the specific service on ASP 130. Such an ALDP protocol allows ALSRGW 140b to open up an application session with the appropriate service on application server 131. For example, it could be the POP3 service offered on ASP 130, and the TCP port accessed by ALSRGW 140b would be “110”. The ALDP protocol also configures the label maps in ALSRGW 140a and ALSRGW 140b with tier-2 labels to exchange data traffic between the standard application 112 and the specific service on application server 131.

In system 100, when the standard application 112 sends data traffic for the remote service, the local socket server residing on ALSRGW 140a receives it. ALSRGW 140a applies two labels to this data. The inner label is for the tier-2 ALSP that identifies the service on application server 131, and the outer label is for the tier-1 ALSP that identifies ASP 130. When ALSR 160 receives this data, it inspects the outer label and identifies that the data must be sent to ALSRGW 140b. ALSR 160 then pops off the outer label and forwards the data to ALSRGW 140b. When ALSRGW 140b receives the data, it pops off the inner label and identifies that the data must be sent to the application session opened up earlier on application server 131. The reverse traffic from application server 131 to the standard application 112 uses a similar method.

In system 100, since the application session of 112 is terminated at a local port, even if ALS session 113 drops due to poor wireless coverage or a new IP address acquired by the mobile device 110, the application session of the standard application 112 will stay on. On the other hand, the other application session which originates at ALSRGW 140b and resides in the fixed network and application server 131 does not drop because this session will not be affected by ALS session 113. As soon as the communication problem between ALSRGW 140a and ALSR 160 is fixed, ALS session 113 is automatically recreated according to this embodiment. Once ALS session 113 is recreated, the data traffic flows normally as if no communication problems have happened other than application traffic delay.

System 100 includes only one mobile device 110 and one ASP 130. It can be appreciated that same procedure applies for multiple mobile devices and multiple ASPs. The application sessions between the standard application 112 and ALSRGW 140a, and between application server 131 and ALSRGW 140b are unbreakable sessions. Whereas, the sessions between ALSRGW 140a and ALSR 160, and between ALSRGW 140b and ALSR 160 are breakable sessions. In system 100, application data passes between ALSRGW 140a and ALSRGW 140b using two breakable sessions.

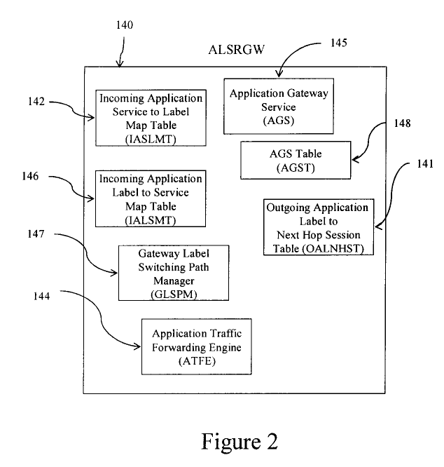

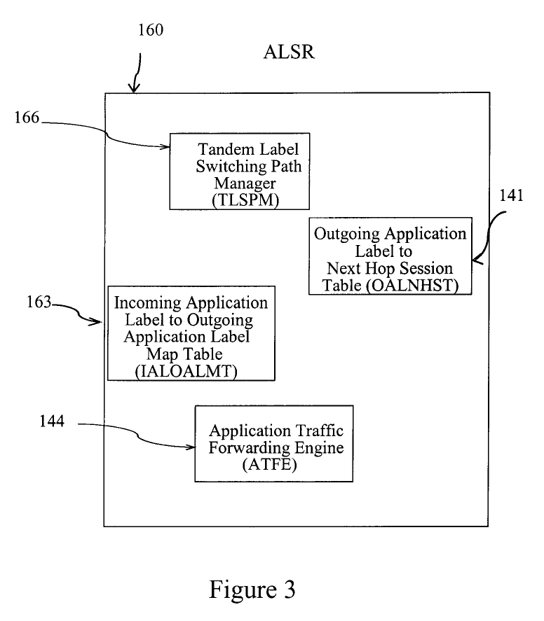

FIG. 2 illustrates a block diagram of an exemplary ALSRGW, according to one embodiment of the present invention. FIG. 3 illustrates a block diagram of an exemplary ALSR, according to one embodiment of the present invention. An ALSRGW and an ALSR share some functionalities.

In FIG. 2, the application gateway service (AGS) 145 terminates application sessions generated from a standard application (such as 112) or originates session to an application server (such as 131). In other words, AGS 145 maintains sessions with all standard applications and application servers using a standard interface, such as TCP or UDP sockets, or a standard application program interface.

ALSRGW 140 contains an incoming application service to label map table (IASLMT) 142 that provides a label for an unlabeled data. For example, depending on which local port of AGS an application session has been terminated to, the unlabeled data will be labeled with a certain label from the IASLMT 142. Therefore, in one embodiment of this invention, IASLMT 142 contains a series of mappings between local ports and outgoing labels.

Outgoing application label to next hop session table (OALNHST) 141 contains mappings between an outgoing label and an outgoing ALS session. As shown in FIGS. 2 and 3, OALNHST 141 exists on both ALSRGW 140 and ALSR 160. OALNHST 141 also indicates what type of operation needs to be performed on the labeled data. Valid operations are push, pop, swap, and no operation. In a push operation a new label is pushed onto a label stack where the new label becomes the outer label. In a pop operation, the topmost label from the data is removed. In a swap operation, the topmost label is replaced with another label. In a no operation, the labeled data is forwarded without any changes made to the label stack. In FIG. 2, ALSRGW 140 selects an outgoing label by consulting the IASLMT 142 and then sends the data to an outgoing ALS session by consulting the OALNHST 141.

The incoming application label to service map table (IALSMT) 146 is consulted for mapping a label of incoming data to an appropriate service. A service can be defined, for example, by an internet protocol address, a port, or a standard application programming interface (API) function.

Application gateway service table (AGST) 148 is consulted by AGS 145 when creating a new ALSP between two ALSRGWs.

As shown in FIGS. 2 and 3, application traffic forwarding engine (ATFE) 144 maintains all the ALS sessions with other relevant ALSRs and ALSRGWs in a system. Based on the outgoing label, an ALS session is chosen from the OALNHST 141 and then sent to the appropriate ALS session via ATFE 144.

In FIG. 3, the incoming application label to outgoing application label map table (IALOALMT) 163 in ALSR 160 contains mappings between labels of incoming data from other ALSRs or ALSRGWs to outgoing application labels. When ALSR 160 receives labeled data, it inspects the label and consults the IALOALMT 163 to get an outgoing label. It performs the label operation as suggested by the OANLHST 141. It also uses OALNHST 141 to identify an appropriate ALS session. Once the ALS session is identified it sends the data to the session via ATFE 144. The tandem label switching path manager (TLSPM) IN ALSR 160 creates, updates and maintains the label mapping tables in ALSR 160, according to one embodiment.

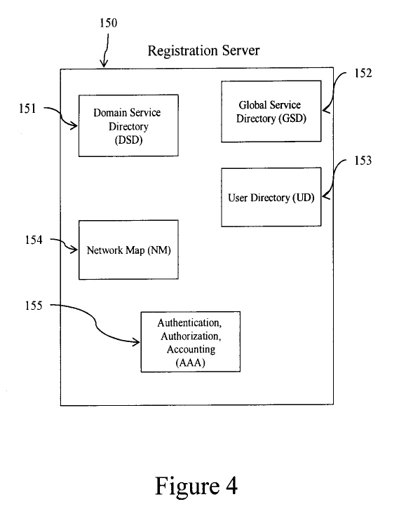

FIG. 4 illustrates a block diagram of an exemplary registration server, according to one embodiment of the present invention. The domain service directory (DSD) 151 provides mappings from a given ASP domain and service to a label that must be used by an ALSR to access the service offered by the given ASP. It should be noted that this label is unique only in the given ASP domain.

Global service directory (GSD) 152 contains mappings from a given global service to a label that must be used by an ALSR to direct application traffic to the given global service. Such a label is unique in the entire system. A global service is not tied to any specific ASP; and, it can be offered by one or more ASPs in an anonymous way.

User directory (UD) 153 maintains all the subscribers' information and the ASPs and services that each subscriber has registered.

Authentication, authorization, and accounting (AAA) 155 provides authentication, authorization and billing service for all the subscribed users.

Network map (NM) 154 contains the network connectivity information for all the ALSRs 160 and some ALSRGWs 140 (usually ALSRGWs in the wired network) in a system. This information is used to build the wired infrastructure for an ALS based system. An ALSR 160 or ALSRGW 140 receives all the information on its neighboring ALSRs 160 and ALSRGWs 140 from NM 154. According to the received information, an ALSR 160 or an ALSRGW 140 creates the relevant ALS sessions using the implicit ALSP setup mechanism.

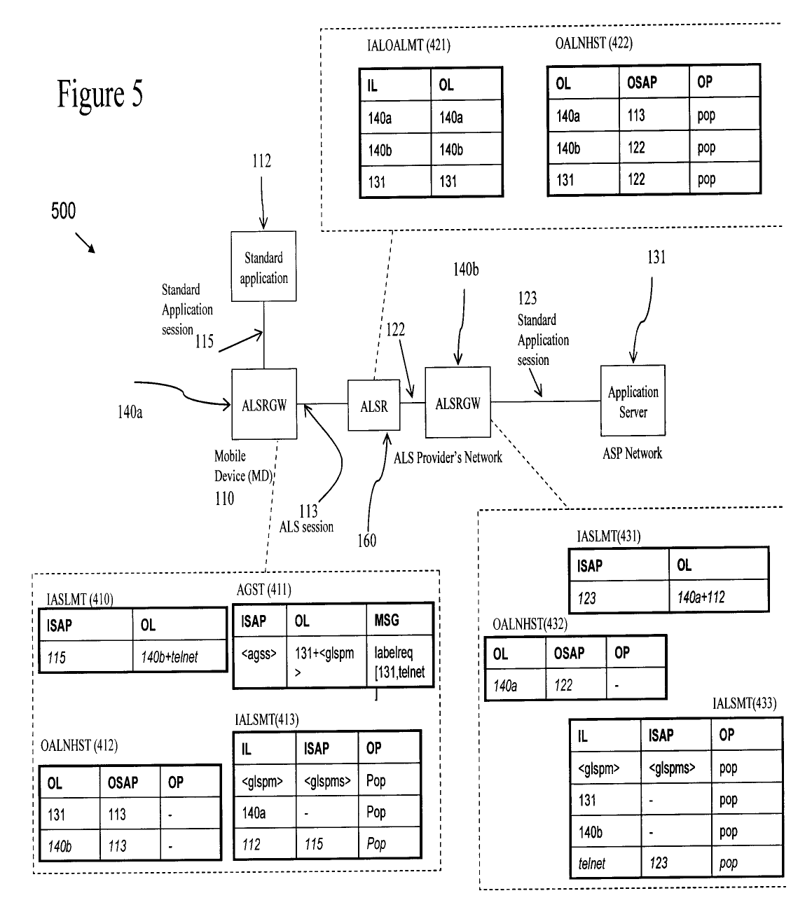

FIG. 5 illustrates a block diagram of exemplary internal tables in an application label switching router and an application label switching router gateway, according to one embodiment of the present invention. In system 500, when all the ALSRs 160 and ALSRGWs 140 register they populate the respective tables with tier-1 ALSP information using the implicit ALSP setup mechanism. This example explains the setup of a tier-2 ALSP with respect to a standard application trying to get access to an ASP service, according to one embodiment.

In this example, when ALSRGW 140a registers with RS 150 it receives the information on application server 131 and the ‘telnet’ service it is allowed to access. ALSRGW 140a updates its AGST 411 with this information. AGS 145 opens up a local service access point (i.e., a TCP socket listener) shown as <agss> in AGST 411 (i.e., this could be a local TCP port 8123). The entry in AGST 411 suggests that if a standard application opens a session at <agss>, an ALSP will be created with the service pointed by the stacked labels 131 and ‘telnet’.

If the standard application 112 opens up a session with the <agss> service access point as shown in FIG. 5, AGS 145 creates a local application session 115 for the standard application 112. AGS 145 consults AGST 411 and sends an application label request message using the stacked labels 131 and <glspm>. The outer label 131 routes this packet to any ALSRGW servicing the ASP 131 (in this example it is 140b ). The inner label <glspm> is a reserved label that identifies a gateway label switch path manager (GLSPM) 147 residing on an ALSRGW. In the application label request message ALSRGW 140a provides that the final session should be with ASP 131 and its ‘telnet’ service. ALSRGW 140a also provides the returning labels that the other party must use for return traffic. The stacked returning labels are 140a and 112. The outer label 140a will identify ALSRGW 140a and the inner label 112 will identify session 115. ALSRGW 140a adds an entry in IALSMT 413 (last row), indicating that if it receives data with label 112 the operation should be to pop off the label and then forward the unlabeled data to session 115.

According to the first row in OALNHST 412, ALSRGW 140a forwards the label request message to session 113. Upon receiving the data, ALSR 160 inspects the topmost label to be 131 and uses IALOALMT 421 to identify 131 as the outgoing label. It swaps the incoming label with the outgoing label (nothing needs to be done as they are the same in this example). ALSR 160 then uses the last row in OALNHST 422 to pop the outer label and forward the data to session 122.

When ALSRGW 140b receives the data from session 122, it inspects the outer label to be <glspm>. Using the first row of IALSMT 433, ALSRGW 140b pops the label and provides the unlabeled data to GLSPM 147. GLSPM 147 identifies the data as a label request message. It decodes the message and identifies the application server 131 and its ‘telnet’ service. It opens up a session 123 with the application server 131 at the ‘telnet’ service access point. GLSPM 147 also decodes the returning labels provided by the sender ALSRGW 140a, and places an entry to IASLMT 431. This entry suggests that any data received from session 123 is labeled with the stacked labels 140a and 112. ALSRGW 140b also identifies the labels the sender should use to send data over this new application session. The labels are 140b and ‘telnet’. ALSRGW 140b adds an entry to IALSMT 433 (last row). According to this entry, if data is received with label ‘telnet’, the data will be sent to session 123 after popping off the label. ALSRGW 140b then generates an application label-mapping message and sends it to GLSPM 147 residing on the sender ALSRGW 140a. This message contains the labels the sender must use, which is 140b and ‘telnet’. When GLSPM 147 receives this label-mapping message, it creates an entry in IASLMT 410 to indicate that any data received over session 115 will be labeled with 140b and ‘telnet’. The standard applications send and receive data.

When standard application 112 sends data over session 115, the data is labeled with 140b and ‘telnet’ and is forwarded over session 113. ALSR 160 receives this labeled data, checks its tables (421 and 422), pops the outer label, and forwards the data over to ALSRGW 140b via session 122. ALSRGW 140b receives this data, identifies the outgoing session 123 by consulting its tables for the label ‘telnet’, pops off the label, and sends the unlabeled data over to the application server 131 via session 123. The returning data takes a similar route. It can be appreciated that the standard application 112 and the application server 131 are transparent to all these label switching mechanisms.

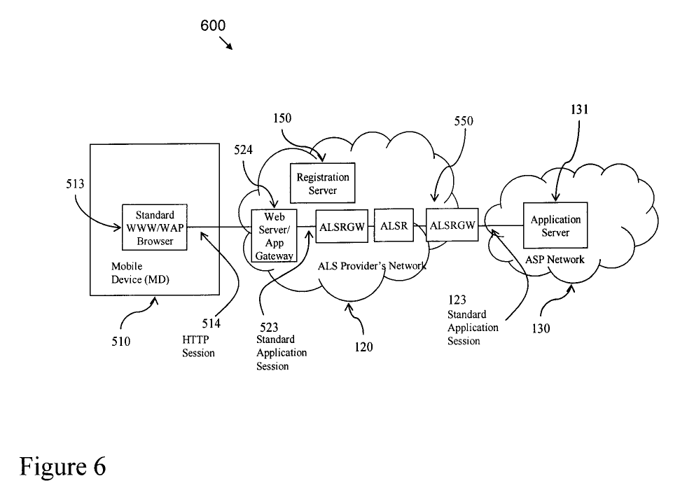

FIG. 6 illustrates a block diagram of an exemplary ALS unaware mobile device that accesses services offered through an ASP, according to one embodiment of the present invention. In system 600, the mobile device 510 is unaware of the ALSR solution and uses a standard Web or WAP browser to access the Internet. According to one embodiment, the ALS provider's network 120 contains a web server 524 that serves web pages to take advantage of the services provided by 120. When the web browser 513 accesses one of such service based pages from the web server 524, the web server 524 converts web browser's 513 request into application data and uses the standard application session 523 to access the relevant service. For example, a push email service can be implemented using the above-mentioned method in the following manner. A mobile user subscribes for a push email service from an ASP 130. Registration server 150 is configured with the appropriate ASP domain and service information for the subscriber. The web server/app gateway 524 plays a dual role. On one hand, it acts as a standard web server for mobile device 510. On the other hand, it acts as an application gateway and communicates with the subscriber's mailbox residing in ASP 130 through ALSRGW 550 via application label switching as described before. If the email server polling application running on 524 detects an incoming email for the subscriber, it sends a WAP push message to the mobile device 510 using a standard WAP push method. This push message launches the WWW/WAP browser 513 and points it to a specific web page residing on web server/app gateway 524. When this web page is accessed, a web service residing on 524 uses a standard email protocol such as POP3 to retrieve the email from the application server 131. The received email is displayed through the standard web pages on WWW/WAP browser 513.

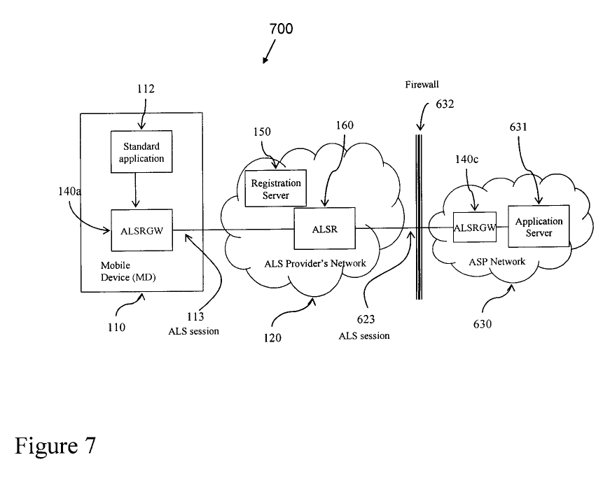

FIG. 7 illustrates a block diagram of an exemplary enterprise model where mobile users can access data behind-the-firewall, according to one embodiment of the present invention. In system 700, an ALSRGW 140c resides on ASP 630. According to the network map 154, ALSRGW 140c is required to open up an ALS session 623 with ALSR 160. ALSRGW 140a on the mobile device 110 is configured to use services from ASP 630. ALSRGW 140a also opens up an ALS session 113 with ALSR 160. To access the application server 631, the application data originated from the standard application 112 are encapsulated with two stacked labels. The outer label is used to route the application data to ALSRGW 140c using an application label switching method as described above. When the data reaches 140c, the inner label is used to send the data to the appropriate application session with the application server 631. The ALS provider's network 120 does not open up an incoming connection with ASP 630, instead, ALSRGW 140c opens up a session with ALSR 160. Therefore, the firewall 632 residing on ASP 630 does not need to open a “hole” in the firewall.

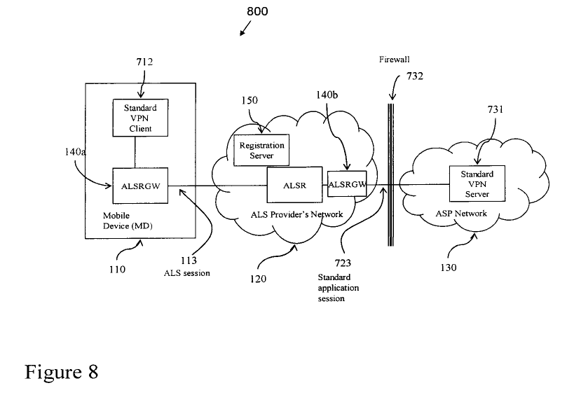

FIG. 8 illustrates a block diagram of an exemplary VPN client on a mobile device that achieves mobility using the ALS system, according to one embodiment of the present invention. In system 800, ASP 130 does not run any custom ALS hardware or ALS software. ALSRGW 140a already knows the label required to access the VPN server 731 at ASP 130. The standard VPN client 712 is configured to treat the local TCPJUDP port as configured in ALSRGW 140a to be the destination VPN server. All data sent from VPN client 712 is labeled and switched to VPN server 731 using the application label switching method discussed before. If the mobile device 110 changes the point of attachment, loses wireless coverage, or acquires a new IP address, ALS session 113 will automatically be re-established once the data service is available. Therefore, in system 800, a VPN session between VPN client 712 and VPN server 731 never drops.

Although the present method and system have been described in connection with a software update service system, one of ordinary skill would understand that the techniques described may be used in any situation where label switching is useful.

A method and system for device mobility using application label switching in a mobile communication network are disclosed. Although the present methods and systems have been described with respect to specific examples and subsystems, it will be apparent to those of ordinary skill in the art that it is not limited to these specific examples or subsystems but extends to other embodiments as well.

I claim:

1. A method, comprising:
establishing an application session involving a first computing device, a second computing device, a client application and a server application, wherein the application session includes,
a first unbreakable session between the client application and the first computing device,
a second unbreakable session between the server application and the second computing device, and
one or more breakable sessions between the first computing device and the second computing device;
maintaining the first unbreakable session and the second unbreakable session when the one or more breakable sessions terminate;
creating one or more new breakable sessions when the one or more breakable sessions terminate;
reestablishing the application session with the one or more new breakable sessions, the first unbreakable session and the second unbreakable session.

2. The method of claim 1, wherein the first computing device is connected to a first application label switching router gateway, and the second computing device is connected to a second application label switching router gateway.

3. The method of claim 2, wherein the one or more breakable sessions are established with additional computing devices connected to application label switching routers.

4. The method of claim 1, wherein the first unbreakable session is maintained with the application session exclusively and wherein the one or more breakable sessions multiplex a plurality of application sessions.

5. The method of claim 1, wherein the first computing device is a mobile device.

6. The method of claim 1, further comprising:
establishing the application session when an application opens the first unbreakable session on an interface of the first computing device, wherein the application comprises one or more of a web browser, an FTP client, and a multimedia player, and wherein the interface comprises one of a TCP port, and inter process communications interface, an application programming interface and a UDP port.

7. The method of claim 6, wherein establishing the application session further comprises:
configuring a first application label in a first label switching router that communicates with a second application label switching router;
configuring a second label in the second application label switching router that communicates with the first application label switching router; and
notifying the application that the application session is complete.

8. The method of claim 6, further comprising:
terminating the application session upon a terminating event, the terminating event comprising one or more of: the application tearing down the unbreakable session, and a first application label switching router determining a second application label switching router not having a matching label mapping.

9. The method of claim 8, wherein terminating the application session further comprises:
sending label teardown messages to one or more application label switching routers.

10. The method of claim 1, further comprising:
reestablishing the application session when a label mapping is lost, and the unbreakable session is maintained.

11. The method of claim 1, further comprising providing an address and a location of an application associated with the application session from a first application label switching router gateway to a second application label switching router gateway.

12. The method of claim 11, further comprising provisioning the address and the location when the first application label switching router gateway registers with a registration server.

13. The method of claim 11, further comprising provisioning the address and the location when the first application label switching router gateway is configured to support the application.

14. The method of claim 1, further comprising restricting access to the server application to one or more users.

15. The method of claim 1, further comprising configuring one or more application label switching router gateways into domains, such that application label switching routers within a common domain only communicate with each other.

16. The method of claim 1, wherein a data protocol associated with the one or more breakable sessions is changed dynamically without disrupting the application session.

17. A communication system, comprising:
a first communication node, in communication with a second communication node;
a first application label switching router gateway coupled with the first communication node; and
a second application label switching router gateway coupled with the second communication node.

18. The communication system of claim 17, further comprising one or more application label switching routers between the first and second application label switching router gateways.

19. The communication system of claim 17, wherein one or more application sessions are established over a first breakable session between the first communication node and the second communication node.

20. The communication system of claim 17, wherein the first application label switching router gateway prep ends one or more labels to application data sent to the second communication node.

21. The communication system of claim 17, wherein the first application label switching router gateway detects the presence of an alternate communication medium; creates a second breakable session using the alternate communication medium, the alternate communication medium including one of: WiFi, BlueTooth, Ethernet, cellular system, and USB; switches to the second breakable session; and terminates the first breakable session without disrupting the one or more application sessions.

22. The communication system of claim 17, wherein the first application label switching router gateway redirects application data sessions from a client application to the first application label switching router gateway.

23. The communication system of claim 22, wherein redirection uses a SOCKS proxy.

24. The communication system of claim 22, wherein redirection uses an NDIS layer in WIN32.

25. The communication system of claim 22, wherein redirection modifies IP address and port information on IP packets representing the application data.
